(19) United States
(12) Patent Application Publication
(10) Pub. No.: US 2010/0235403 A1
(43) Pub. Date: Sep. 16, 2010

(54) Method and system for on-line edit flow peer review

(75) Inventors: Paulo Ney de Souza, Berkeley, CA (US); Robion C. Kirby, Berkely, CA (US)

Correspondence Address: QUINE INTELLECTUAL PROPERTY LAW GROUP, P.C., P O BOX 458, ALAMEDA, CA, 94501, US

(73) Assignee: Mathematical Science Publishers Department of Mathematics University of California, Berkeley, Berkeley, CA (US)

(21) Appl. No.: 12/657,297

(22) Filed: Jan. 14, 2010

Related U.S. Application Data
(60) Provisional application No. 61/144,445, filed on Jan. 14, 2009.

(51) Int. Cl. G06F 3/01; G06F 17/30

(52) U.S. Cl. 707/802; 715/752; 707/E17.005; 707/E17.044

(57) ABSTRACT

Methods and systems for journal peer review particularly for managing online peer review transactions over a network or communications medium such as via the Internet. In specific embodiments, that system minimizes or eliminates the need for most participants to remember and/or enter any login or password information. In specific embodiments, a majority of user interactions are prompted by email or text messages that allow for easier user access and acceptance. In specific embodiments, active links are distributed with each message for easy user access. In specific embodiments, automatic conflict checking is performed.

### CROSS REFERENCE TO RELATED APPLICATIONS

This application claims priority from provisional patent application 61/144,445, filed 14-Jan.-2009 and incorporated herein by reference.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### APPENDIX

This application is being filed with paper appendices. These appendices and all other papers filed herewith, including papers filed in any attached Information Disclosure Statement (IDS), are incorporated herein by reference. The appendix contains further examples and information related to various embodiments of the invention at various stages of development.

Appendix A sets out selected example automatically generated letters (that can be transmitted by a variety of means, e.g., email, postal mail, phone messages, etc.), with embedded unique activation links, generated from a copyrighted software program, owned by the assignee of this patent document, which manifests aspects of the invention.

Appendix B sets out selected example database structure code from a copyrighted software program, owned by the assignee of this patent document, which manifests aspects of the invention.

Appendix C sets out an example questionnaire from a copyrighted manual, owned by the assignee of this patent document, which manifests aspects of the invention.

Permission is granted to make copies of the appendices solely in connection with the making of facsimile copies of this patent document in accordance with applicable law; all other rights are reserved, and all other reproduction, distribution, creation of derivative works based on the contents, public display, and public performance of the appendix or any part thereof are prohibited by the copyright laws.

### FIELD OF THE INVENTION

The present invention relates generally to conducting peer reviews and other reviews of such submissions as journal articles or requests for proposals or grants. In particular embodiments, the invention relates to a system and/or method for complex online peer review transactions that minimizes or eliminates the need for most participants to remember and/or enter any login or password information. In further embodiments, the invention relates to an automated system for peer review that can be modified to accommodate a variety of different review processes.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

At present, most academic journals, as well as business and trade journals, are profitable outputs of publishing corporations. While not-for-profit journals exists, big commercial journals that charge in the range of 40 cents to over 100 cents per page per subscription are still a predominant portion of the field.

As a result, some communities that use refereed publications as part of their work have come together to facilitate not-for-profit publishing and there is an ongoing need for better methods and systems to facilitate peer-reviewed publishing.

Jane (Journal/Author Name Estimator), for example, is a web-based application that, on the basis of a sample text (e.g., the title and abstract of a manuscript), can suggest journals and experts who have published similar articles and is designed for reducing the cost of facilitating peer review. (See Graham Steel; Martijn J. Schuemie and Jan A. Kors, Jane: Suggesting Journals, Finding Experts, Bioinformatics, Jan. 28, 2008; bioinformatics(.)oxfordjournals(.)org/cgi/content/abstract/btn006v1

Other references, such as “Reducing the cost of facilitating peer review”, by Martijn J. Schuemie and Jan A. Kors, Jane: Suggesting Journals, Finding Experts, Bioinformatics, Jan. 28, 2008, discuss systems and methods such as providing assistance to scientists in determining which journal is most appropriate for publishing their results, and which other scientists can be called upon to review their work.

U.S. Pat. Nos. 7,539,938 and 7,219,301, Systems and methods for facilitating the peer review process, discusses integrating the peer review process with other applications using a user interface linked to a peer review application having knowledge base information and rules for accepting a paper for peer review, assigning the paper to one or more of a defined set of reviewers for review, providing to the reviewers one or more criteria to be used for reviewing and evaluating each paper for enabling each reviewer to create a peer review result, and processing all peer review results for any paper to produce a peer review report.

U.S. Pat. No. 7,007,232, System and method for facilitating the pre-publication peer review process, discusses facilitating peer review using a computer based manuscript tracking process the uses the World Wide Web to allow ubiquitous access to the manuscript under review in conjunction with automatic generation of potential reviewers and instant notification to authors, editors, and reviewers of significant milestones in the peer review process. Authors are allowed to communicate with anonymous reviewers to reduce the number of revisions leading to approval. Additionally, multiple authors are allowed to collaborate during the manuscript creation process as well as the manuscript review process.

Other various strategies have been proposed for online collaboration and/or review.

Whether for journal peer review or for collaborative review of other proposals, such as grant proposals, bidding or purchase proposals, etc., one impediment to efficiently automating the process is making the electronic collaboration simple enough for reviewers that they are willing to use it and participate in the process.

### SUMMARY

According to specific embodiments, the present invention is involved with methods and/or systems and/or devices that can be used together or independently to facilitate collaborative peer review of various papers or submissions, such as technical, scientific, or business papers, or grant proposals, or requests for bids or responses thereto, research proposals, etc.

Various embodiments of the present invention provide methods and/or systems for peer review over a communications network such as the WWW. According to specific embodiments of the invention, a client system is used by various users to access the system. Where necessary, a client system is provided with a set of interfaces that allow a user to read and review email and open forms and documents in any of a variety of well-known formats. The client system displays information pertinent to a user (e.g., an author, editor, or reviewer) and displays an indication of an action that a user is to perform to proceed with the review process. According to specific embodiments of the invention, such indications include a unique active link (such as a URL attached to a text or graphic element) or similar identified address indications in an email or similar communication and can also include a form or similar document displayed in a browser or other reader application. In response to a user input, the client system sends to a server system the necessary information to access a publication and peer review database. The server system uses the request data, and optionally one or more sets of server data, to process the request. According to specific embodiments of the present invention, a client system is, or has previously been, provided with an executable code file that allows the client system to receive data and present data to a user, such as a browser or email client.

Thus, in further embodiments, the present invention may be understood in the context of facilitating peer review over a communication media. An important application for the present invention, and an independent embodiment, is in the field of providing a peer review system over the Internet or world-wide-wed (WWW), optionally using Internet media protocols and formats, such as Java, scripts, HTTP, RTTP, XML, HTML, dHTML, VRML, as well as image, audio, or video formats etc. However, using the teachings provided herein, it will be understood by those of skill in the art that the methods and apparatus of the present invention could be advantageously used in other related situations where users access content over a communication channel, such as modem access systems, institution network systems, wireless systems, etc. The present invention is involved with a number of unique methods and/or systems that can be used together or independently to facilitate publishing and peer review over a communications media. In specific embodiments, the present invention can be understood as involving new business methods related to publishing papers or journals.

Various embodiments of the present invention provide methods and/or systems for peer review that can be implemented on a general purpose or special purpose information handling appliance using a suitable programming language such as Java, C++, Cobol, C, Pascal, SQL, Perl, Fortran., PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

While may variations should be understood and within the scope of the present invention, in a preferred embodiment, the invention can be understood as a method of a peer review and edit process for publications that uses a server computer system and a data base to efficiently handle a variety of tasks related to peer review. The term “computer system” should be understood herein as including, in various embodiments or implementations, one or more logic processes, either distributed or located in a single machine, that function to perform the invention. The term “database” should be understood herein as including, in various embodiments or implementations, one or more areas of data storage, either distributed or located in a single machine, that function to perform any data storage functions of the invention.

An important action of the invention is to automatically or semi-automatically generate communications to various participants in the peer review process. In most cases, such communications are best understood as email messages, but such communications could include any other mode of communicating with participants, including printed mail, telephone text messages, telephone messages, etc. As will be seen from the materials provided herein, some template messages are designated as “automatic” and some as “at editor's discretion.” Discretionary messages are semi-automatic in the sense that the messages are generated from templates and filled out from the database and an editor may be prompted to send them our or may send them out at his or her own initiative.

A further important action of the invention is generating and making available what is termed an “active link” herein. Such a link may be any text or graphic or other indication to a recipient of a message from the invention that allows that recipient to take an action relevant to the peer review process. Such actions can include one or more of: (1) accepting a peer review assignment, (2) rejecting a peer review assignment, (3) providing an indication and/or confirmation for an alternative or additional peer reviewer; (4) downloading a paper for review; (5) uploading comments and/or a report and/or revisions; (6) submitting a final version of a paper; etc. In specific embodiments of the invention, an active link allows a recipient to take some action without having to “logon” to a website or remember a password. A system according to specific embodiments of the invention provides one or more review flows as described herein, which is some cases may be further customizable as described herein.

In a preferred implementation, an active link of the invention is specific to a particular actor (e.g., an author, reviewer, editor, referee, vote-caster) and a particular submission. A system of the invention maintains the status of any particular actor with respect to a particular submission so that upon accessing the link the actor will interact with the system at the appropriate step in the review process.

Once a recipient has taken some action, a server computer system of the invention receives data back of over said communications channel indicating a user action and/or activation of said active link. In response to that receiving, one or more data fields in a database are updating and various further actions are taken. These further actions can include providing a form for entering additional data, providing a file for review, or providing one or more emails, such as confirmation emails or emails requesting further action from the actor or from an additional actor. At least one of these actions generally involves transmitting at least one data file and/or further email message over said communications channel to said recipient.

A further important aspect of the invention according to specific embodiments of the invention is providing a method and system for automatic peer review that may be used in a variety of peer review settings (e.g., academic journals, grant proposal evaluations, script review, etc.) and can be readily customized for different pre-existing review processes.

### Other Features & Benefits

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. Furthermore, in some aspects, the present invention is described in terms of client/server systems. A number of computing systems and computing architectures are described in the art as client/server art. For the purposes of this description, client/server should be understood to include any architecture or configuration wherein an element acting as a client accesses a remote and/or separate program or device that is providing the desired service (e.g., a server).

All references, publications, patents, and patent applications cited herein are hereby incorporated by reference in their entirety for all purposes.

### BRIEF DESCRIPTION OF THE DRAWINGS

FIG. 1 is a flow chart illustrating a method of managing peer review according to specific embodiments of the invention.

FIG. 2 is a flow chart illustrating major steps in a review process according to specific embodiments of the invention.

FIG. 3A-D are example text communications (such as emails) generated automatically or semi-automatically and containing one or more active links according to specific embodiments of the invention.

FIG. 4 is an example graphical user interface showing a referee status input interface according to specific embodiments of the invention.

FIG. 5 is an example graphical user interface showing a referee report upload interface according to specific embodiments of the invention.

FIG. 6 is an example graphical user interface showing a decision maker interface according to specific embodiments of the invention.

FIG. 7 is an example graphical user interface showing author status data according to specific embodiments of the invention.

FIG. 8 is an example graphical user interface showing a managing editor interface according to specific embodiments of the invention.

FIG. 9 is a flow chart illustrating major steps in a customizable review process according to specific embodiments of the invention.

FIG. 10 is a block diagram showing a representative example logic device in which various aspects of the present invention may be embodied.

### DESCRIPTION OF SPECIFIC EMBODIMENTS

Before describing the present invention in detail, it is to be understood that this invention is not limited to particular compositions or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical and scientific terms used herein have meanings as commonly understood by one of ordinary skill in the art to which the invention pertains. Although any methods and materials similar or equivalent to those described herein can be used in practice or for testing of the present invention, the preferred materials and methods are described herein.

### 1. Overview

In particular embodiments the invention and/or aspects thereof may be incorporated into a system known as EditFLOW™. This system is designed to execute on any reasonably modern server platform, such as a Dell PowerEdge rack-mount servers or others. Typical and most common transactions are not particularly taxing to computer hardware, since they are very much distributed and do not cause many jumps in load. However, some simple actions may require a large number of queries and transactions. For example, the act of uploading a report will cause several dozen columns in the database to be updated as well as several people to be notified by e-mail (editors, managing editor and referees).

In particular embodiments, the invention may be deployed in environments that include a number of other known software elements to provide a variety of services, such as: Linux, MySQL, Apache, PHP, Pear, Perl, TEX, pdftk, SMTP, and other known logic components.

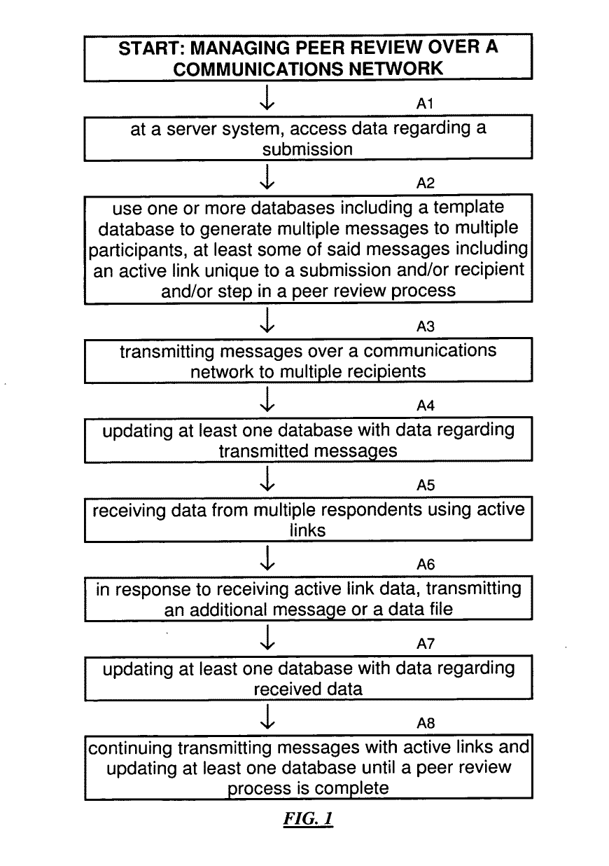

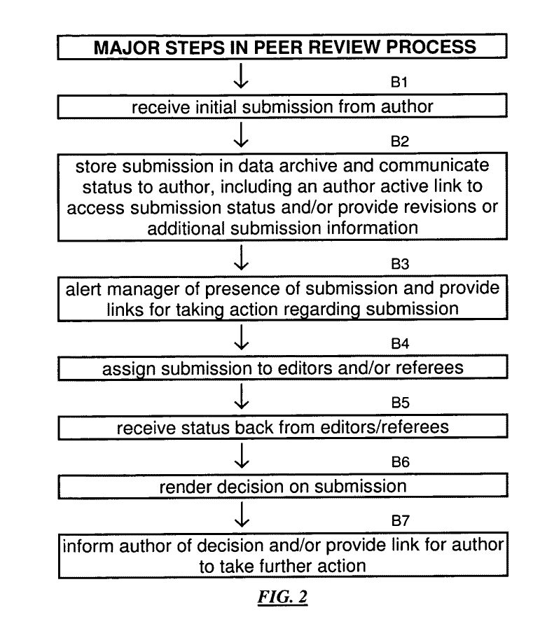

FIG. 1 is a flow chart illustrating a method of managing peer review according to specific embodiments of the invention. FIG. 2 is a flow chart illustrating major steps in a review process according to specific embodiments of the invention.

2. Automatically Generated Communications with Active Links

According to specific embodiments of the invention, as will be understood from the description herein, the invention provides for automatic generation of a number of different communications (e.g., emails, letters, text messages, audio messages, etc.) that relate to review of journal articles or other submissions. In a particular embodiments, one or more of the following example variables may be used in the building of emails/letters as described herein. In particular embodiments, a system according to specific embodiments of the invention is designed to be expandable such that a standard site installation starts at about 90-100 letters but may end with thousands after customizations by editors. Thus, according to specific embodiments of the invention, it has been determined that it is desirable to keep the number of automatically generated communications variables small and with a precise meaning.

An example of variables according to specific embodiments is as follows. While these variables are for an example system used for mathematically journal publishing, it will be readily understood that the variable set can be modified for other types of submissions.

### Journal Variables:

<JNAME> Journal Name.

<JOURNAL> Full name of the Journal.

<JSHORT_NAME> Short name of the Journal (“Involve” for example)

<JGEMAIL> Journal general e-mail.

<ISSN> ISSN for the print journal

<ISSNO> ISSN for the on-line journal

### Editor Variables:

<EDITOR> Editor name

<SALUTATION> Salutation used in the letters, chosen by the journals

<SIGNATURE> Signature used in the letters.

### Author Related Variables:

<AUTHOR> The corresponding author of an article

<AUTHORS> All authors of an article

to <EMAIL> Corresponding author's e-mail

<LICENSES> List of all pending Copyright licenses for the article.

### Article Variables:

<TITLE> Full title of the paper

<TEXTITLE> TeX version of the title

<SUBDATE> The date of submission

<DATE> Various dates depending on the letter.

<VERSION> Version of the article that has been uploaded

<REVDATE> Date of revision of the article

<MSCPRIMARY> Primary Mathematics Subject Classification Code (http://www.ams.org/msc/) for the paper.

<MSCSECONDARY> Secondary Mathematics Subject Classification Code

<REFEREE> Last Name of the referee, suitable for “Dear Prof. Kominez”

<CHANGE> Describes the status of a referee and how it changes.

<TEXAUTHORS> Name of authors in TEX

Variables that Provide Links for the Functionality of EditFLOW:

<LINK> Used with multiple meaning:
Link for an author to upload a revision of an article
Link to an article page (revision_uploaded)
Link to the EditFLOW (submission_to_editor)

<COVERLETTER> Link pointing to the cover letter of an article revision

<CONFIRM-REF> Link to confirm referee assignment

<WHERE> Link to the article page within EditFLow

<STATUS> Link to track status of an article

<STATUSLINK> Link for an author to track status of his paper.

<DEADLINE> Deadline agreed for filling a report

<UPLOAD> Link to upload a report

<FILES> A list of report files that have just been uploaded

<NUMBER> Number of referee reports filled on the article so far.

<VOTEURL> Link to vote on a paper

<NOT> Means “Yes” or “No” depending if a paper is accepted or not.

<HISTORY> Link to the history file for the paper.

<UPLOADLINK> Link to upload a source file

<UPLOADFILE> Name and location of source file uploaded.

<DOWNLOAD> Link to download an article or proofs

### English Internals for Generating Letters:

| | mathjargon = 1 | [symbol] | mathjargon = 0 |
|---|---|---|---|
| <REFREPPLUCAPS> | Referee | [symbol] | Reviews |
| | reports | | |
| <REFREPPLUSMALL> | referee | [symbol] | reviews |
| | reports | | |
| <REFREPORT> | referee report | [symbol] | review |
| <REFNOUNSING> | referee | [symbol] | reviewer |
| <REFNOUNSINGCAP> | Referee | [symbol] | Reviewer |
| <REFNOUNPLU> | referees | [symbol] | reviewers |
| <REFNOUNPLUCAP> | Referees | [symbol] | Reviewers |
| <REFVERB> | referee | [symbol] | review |
| <REFVERBPT> | refereed | [symbol] | reviewed |
| <REFVERBGER> | refereeing | [symbol] | reviewing |

### Metadata for Published Article Variables:

<DOINUMBER> DOI Number for the article

<VOLUME> Volume number where article is published

<ISSUE> Issue number where article is published

<PUBISSUE> Web link for the issue where the article appears

<PUBLINK> Web link for the published article

<STARTPAGE> Starting page of the article

<ENDPAGE> Ending page of the article

<MONTH> Publication month

<YEAR> Publication year

### 3. Email/Letter Templates

According to specific embodiments of the invention, in a basic configuration, about 100 letters (or emails, with the terms used interchangeably unless the context requires otherwise) are used for effective communication with editors, referees and authors. The text of each of the default emails may be reviewed with Editorial Managers and Managing Editors, and may be changed at any time during the process.

In further embodiments, Workflow settings for individual journals must be taken into account by the text of the letters. An example of letters is provided herein as Appendix A. These letters will provide some indication of the overall workflow of the invention. A example title and/or filename for each letter template is as shown in the lower right (e.g., request_referee-en) of each letter.

According to specific embodiments of the invention, communications letters can be modified at two levels—initially by an Editor that wants all his templates in one particular shape or form, and another modification that can be performed by the Editor at the time the letter is sent—the text of the letters is always offered to the Editor for further processing and changes.

### 4. Workflow, Active Links, and Templates

According to specific embodiments of the invention, one important feature is that virtually all communication with outside reviewers that requests any action by a reviewer contains an embedded link. This link is encoded by the system and generated individually for individual participants in a review process for each paper. This link is designed so that a reviewer does not need to log on to a web site or otherwise remember any further information to access the paper, but can simply click on the link to access the paper and/or other information necessary for the review process. In specific embodiments, these links are dynamically generated and encoded such that a user must have the link code to view the paper.

For Example, a potential referee would receive a letter such as found on page A-1, which includes the link: http://wft(.)ams(.)org/scripts/refconf.php?rr=355&s=pqYLbK19buc that a potential referee can activate (e.g., by selecting or clicking) if they wish to either confirm that they will referee the paper or to suggest an alternate referee. The link is personalized for the particular email recipient so that when it is activated, the recipient does not have to provide various login details, but the identity of the recipient, the status and nature of the request, and the paper under consideration is known by the system and available when the recipient activates the link. A form may open that allows the recipient to confirm that they will referee the paper and enter data such as a date that a report will be provided. A confirmation communication, such as A-9, will provide access to the paper through a link, such as http://wft(.)ams(.)org/ uploads/agt/subs/070413-Sakasai/070413-Sakasai-v1.pdf. This email may also confirm a report date and repeat a report upload link, such as http:/wft(.)ams(.)org/scripts/ refrep.php?rr=355&s=pqYLbK19buc.

For Example, an author would receive a communication such as found on page A-2, which includes the link: http://wft(.)ams(.)org/scripts/uploadsource.php?p_id=1187&cr=XkkRRXgMwIs for uploading source materials and files. Again, the link upon activation informs the system of the identity of the author and paper and therefore the author does not need to provide further details.

A potential responsible editor would receive a letter such as A-4. Access to the paper and management its editorial process is performed by simply activating http://wft(.)ams(.)org/scripts/revise.php?p_id=&cr=XkkRRXgMwIs to activate an Editorial Workflow Tool. Note that this link in this example is to the paper and work flow status and is made available to editors and authors.

Note that in the above example, the same link may be provided to a reviewer several times for different functions in the review process. The link encoding identifies the reviewer and the paper and the system stores data regarding where the reviewer is in the overall review process. Note also that some links, such as a general status of the review process, may be used by different users, such as the link above for the status of the paper, which may be provided both to an editor and the author. Alternatively, a different link might be provided to an editor, giving editor access to data such as reviewer comments that may not be available to the author.

According to specific embodiments of the invention, essentially all transactions regarding submission, in-house review, out-side peer review, comments and revisions, and voting are activated and/or confirmed through an automatically generated email that contains one or more active links to a particular form or paper and which generally can be accessed without a user having to logon or remember a username/password.

In alternative embodiments, some users may chose to associate a password or other identification with their accounts in order to further ensure privacy. A reviewer who believes their email might not be completely secure, for example, may wish to make sure that an assistant or other person with access to their email cannot read comments regarding a paper. Thus, according to specific embodiments of the invention, a user may elect and/or be required to provide one piece of identifying information (e.g., a password or social security number or mother's maiden name) before being able to access potentially sensitive materials, such as confidential comments regarding a submission.

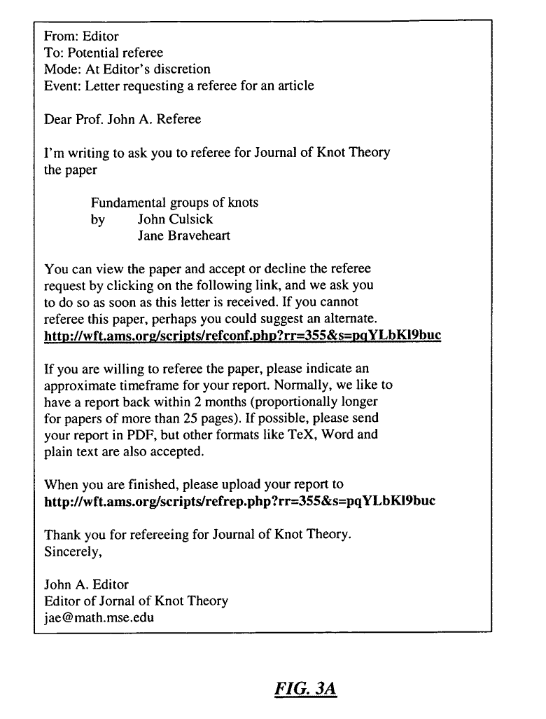

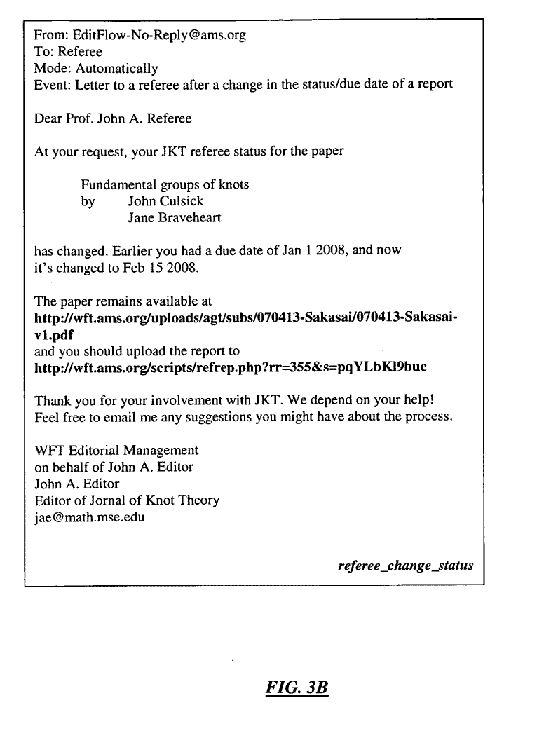

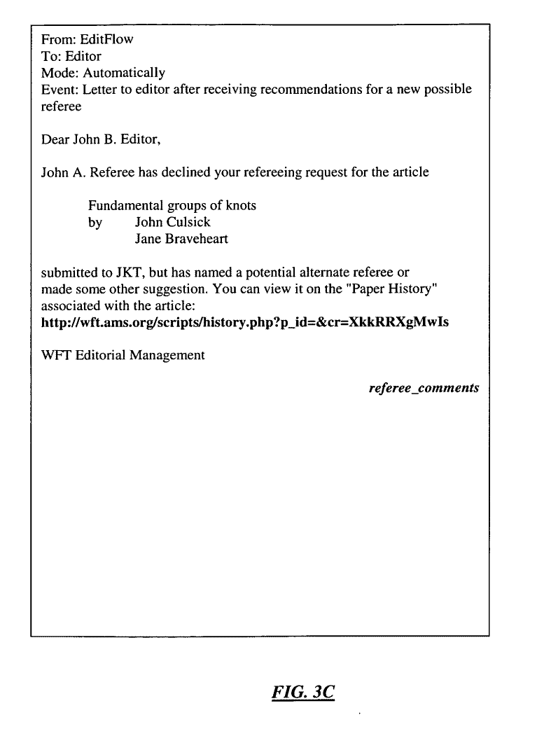

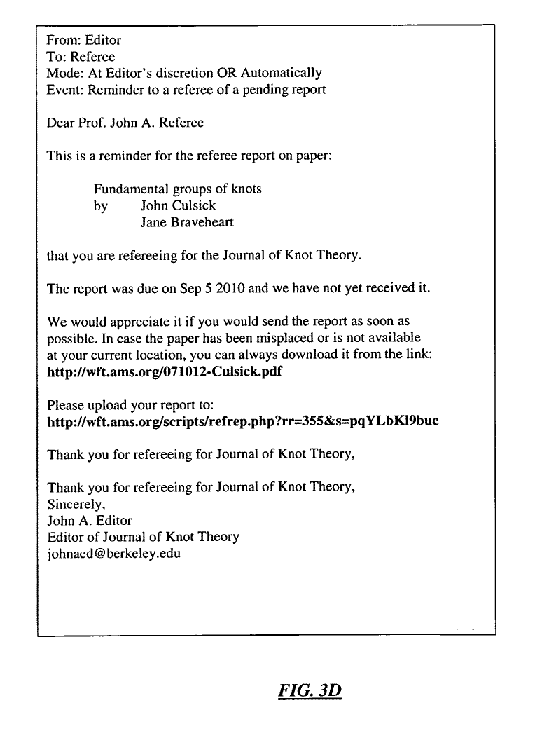

As an example of the use of templates and active links, FIG. 3A-D are example text communications (such as emails) generated automatically or semi-automatically and containing one or more active links according to specific embodiments of the invention.

### 5. Graphical Interfaces

When a user indicates an active link, typically the user is then presented with one or more graphical interfaces appropriate for that active link, specific examples of which are discussed below.

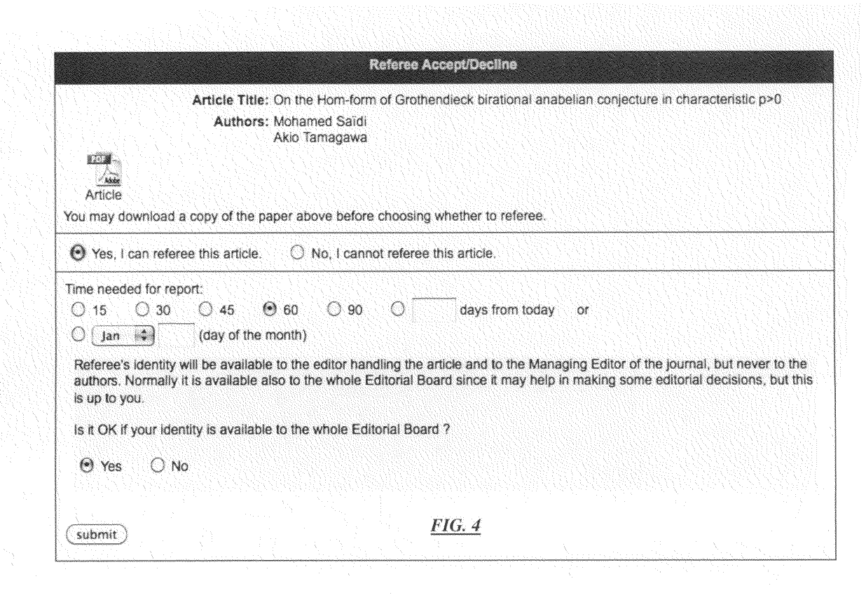

FIG. 4 is an example graphical user interface showing a referee status input interface according to specific embodiments of the invention. In a typical embodiment, this interface will be displayed as a result of a referee indicating (e.g., by clicking) an active link and thereby connecting to a server system of the invention. Alternatively, a referee may paste or type the active link URL into a web browser. FIG. 5 is an example graphical user interface showing a referee report upload interface according to specific embodiments of the invention. In typical embodiments, this will be accessed using the same active link, with the system keeping track of the status of the submission with respect to a particular referee.

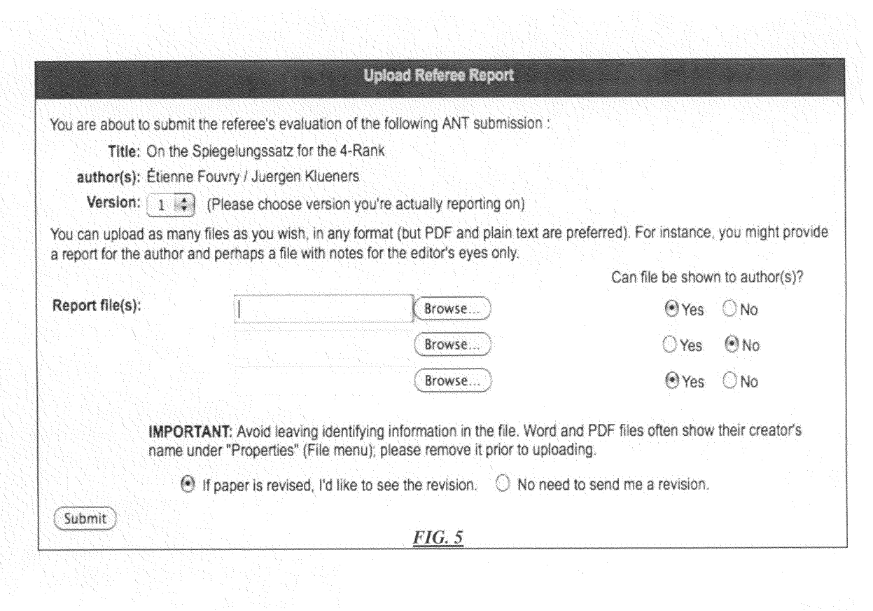

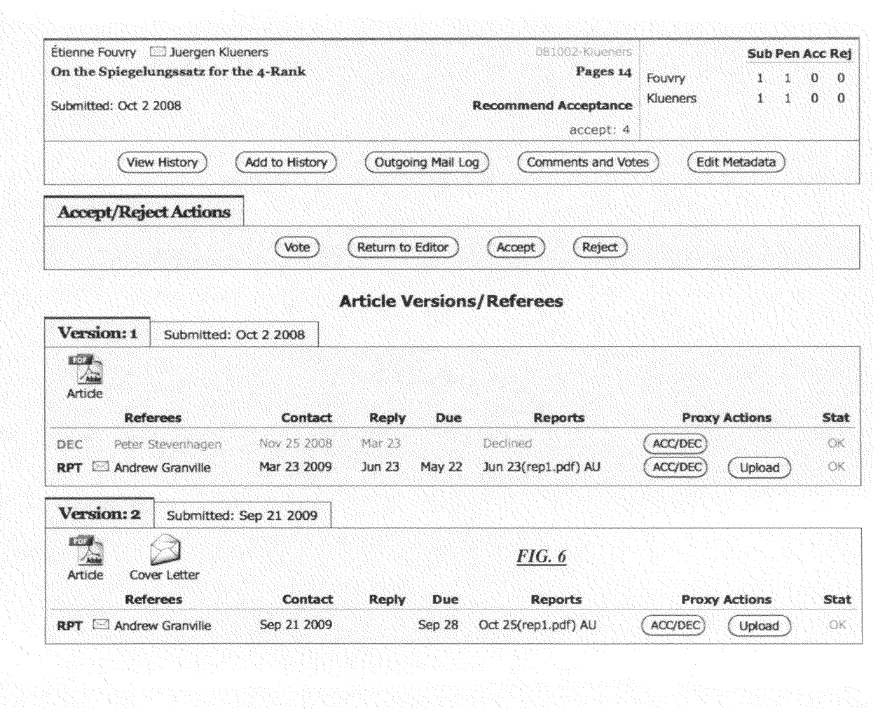

FIG. 6 is an example graphical user interface showing a decision maker interface according to specific embodiments of the invention. As with referees or editors, a decision maker may be requested to render a decision by an automatic or semi-automatic email with an active link that is sent to the decision maker when a submission is ready for a final decision.

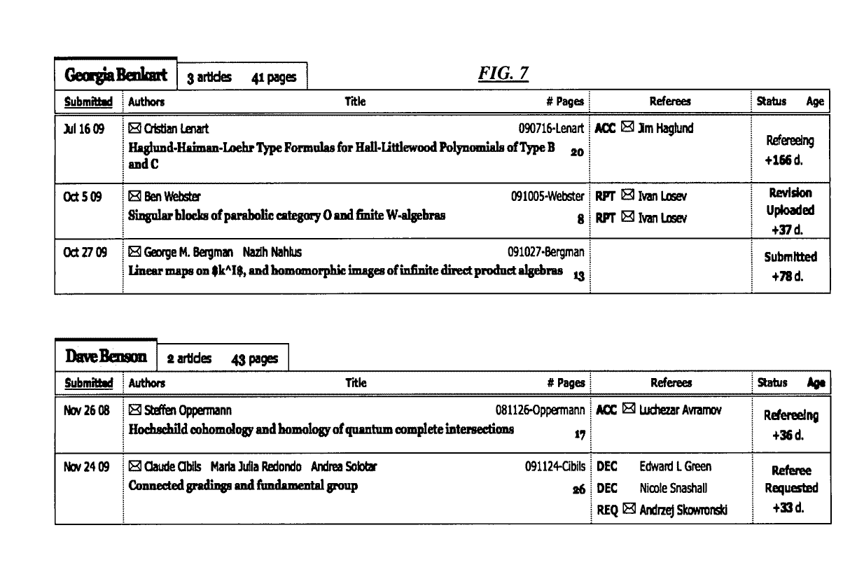

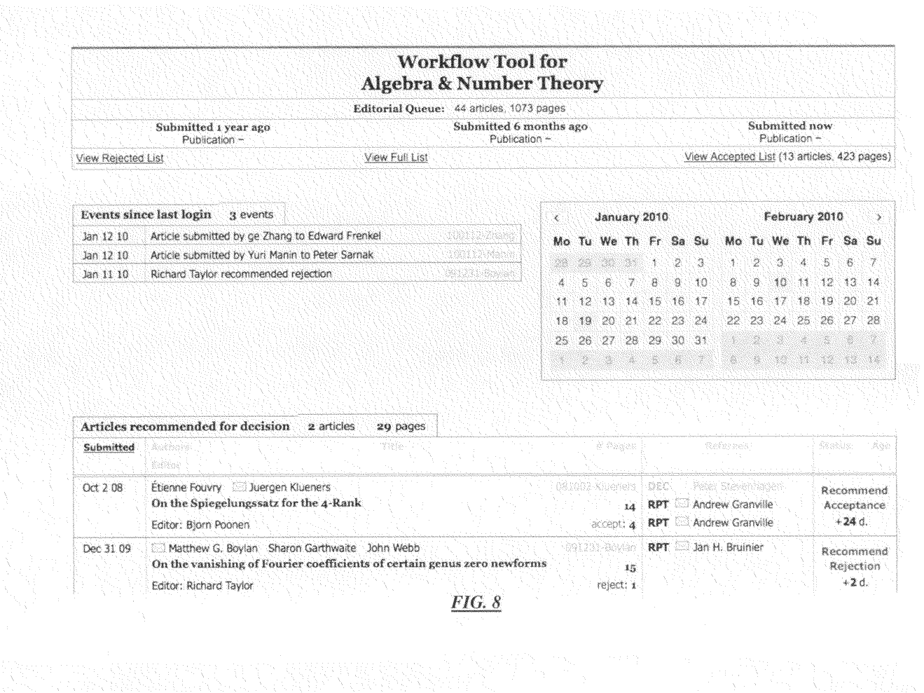

In addition, a variety of graphical under interfaces may be made available by the system to editors and managing editors. FIG. 7 is an example graphical user interface showing author status data according to specific embodiments of the invention. FIG. 8 is an example graphical user interface showing a managing editor interface according to specific embodiments of the invention.

### 6. Example Flow of the Peer-Review Process

An example of an overall peer-review process is discussed below. Note that this example is provided to further illustrate aspects according to specific embodiments of the invention and is not limiting.

A typical process begins when an article is submitted by an author. This submission may be done in a variety of ways, such as via an unsolicited email, via an unsolicited paper mail, or via submission through a web interface, or in response to an email or communication requesting submissions from the author. However submitted, the submission is archived (or stored) electronically in the servers. Typically, at this time, an author will receive a confirmation email with at least one active link indicating where the author can check status and/or provide further revision uploads of this article depending on the journal accepting or not further revisions of the article. If no unrequested revisions are accepted by the journal, no links for this type of revision is provided.

Upon submission, one or more Managing Editors of the journal or grant submission process are notified of the arrival of the submission. This notification may be in an email or in a html form and will generally include at least one active link to a form indicating status of the submission and a link to a copy of the submission itself (e.g., in PDF.)

Depending on process rules established for individual journals, the submission may next be distributed (or assigned) to an Editor for managing of the review process for the particular submission, which could include asking someone for a quick opinion or for a full referee report on the submitted article. Assignment to an editor may take place without any action by the Managing Editor or without any input fron an author. Alternatively, an author may suggest an Editor and/or a Managing Editor may select an Editor.

Where a a full referee report is desired, a URL with a dynamic or encrypted link (an active link) is generated where a possible referee can confirm if he or she will or will not be a referee, confirm a date for the return of the report and/or suggest additional referees. Typically, a referee will receive an encrypted link that is personal to one version of the submission and the referee can upload a report that will be tied to this specific version of the article.

If the author revises the article in any way, and uploads it (assuming that a journal accepts unrequested revisions) then a new version of the same article is created. This new version may be released to the referees (or not) depending on the wishes of the Editor managing the submission process. If a new version is released, the referee may receive a new personalized active link to the new version, or the existing link can be associated in the database with a new version.

When a referee uploads a report, the Editor in charge of the article receives a notification by e-mail and the report is archived in the system for examination. A referee can upload several reports and specify if a report is to be shared with the authors or if it is for “editors eyes only”. This particular marking on every report is visible to the Editor managing the submission and he can then take appropriate actions with the author.

After all reports arrive, the Editor can then request a revision from the authors or go directly to the decision process. Requesting a revision will return the article back to the beginning and the operations may be repeated. An automatic encrypted link is generated at the time to allow only that author to make the upload.

If the Editor decides to go for the decision process—depending on the ones used—the article may be passed to a board for a vote, for unanimous vote, for majority vote, for a unique decision on part of the Managing Editor, or any of the several process implemented for final decision.

Upon decision (acceptance or rejection) a Corresponding Author receives a letter (of acceptance or rejection) that may include further personalized and encrypted links for upload of sources of his article, and correction of his personal metadata, and that of his co-authors. The example emails provided with this application provide further details of example process flows according to specific embodiments of the invention.

### Different Decision Processes

Depending on the decision process used for the Peer-Review process, that may be one or a combination of:
Decision by the Editor himself
Decision by the Managing Editor, upon recommendation by an Editor
Decision by a board of Managing Editor, upon recommendation by an Editor
Decision by a board by unanimous vote
Decision by a board by board-vote (one proposes, one supports and no-one objects)
Decision by a board majority vote

### 7. Flexibility and Customizations

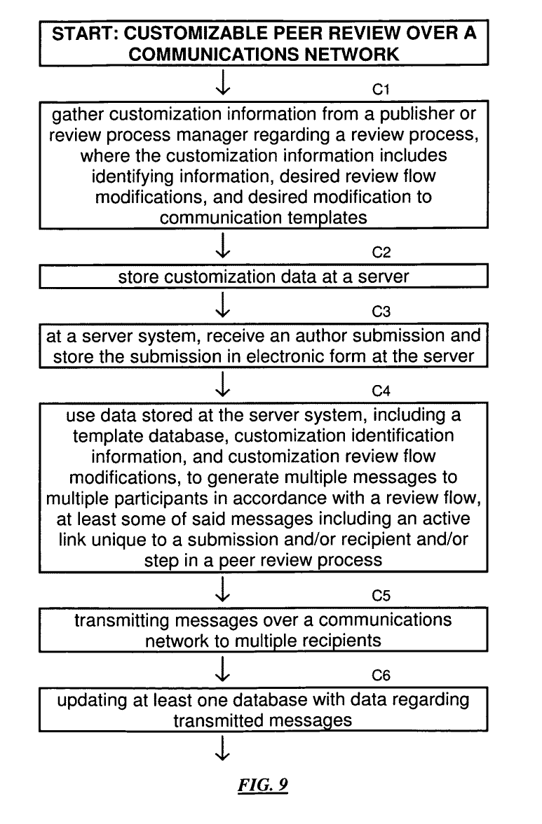

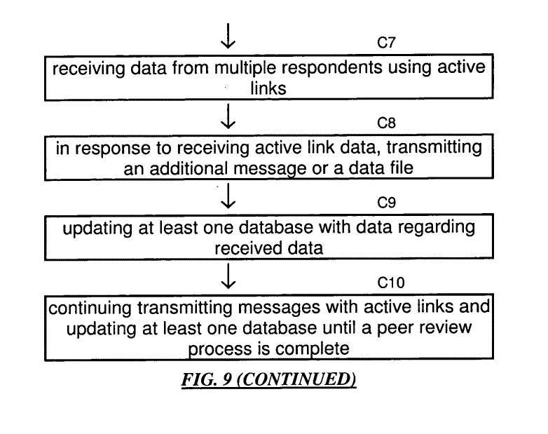

Using the variables and templates as described herein, a edit flow peer review system of the invention may be customized to a variety of different journals and other submission review applications. Customizations for such things as the format of an initial author submission form, whether unrequested revisions are allowed, the number of referees, whether editors can see referee identities, whether authors can suggest editors, whether editors are automatically assigned, etc., can all be easily accommodated according to specific embodiments of the invention because of the flexibility provided by used of the database and templates as described herein. In particular embodiments, various aspects of a peer-review system may be customized by having a journal or other client fill out a simple questionnaire indicating desired aspects of a review work flow. One example of such a questionnaire is provided in Appendix C. Such a questionnaire allows a publication or contract review process to not only provide various names and contact information, but also to affect a number of major steps in the edit flow process. FIG. 9 is a flow chart illustrating major steps in a customizable review process according to specific embodiments of the invention.

### 8. Conflict of Interest Model

A large problem in peer reviewed editing systems is the issue of conflicts of interest between both authors and editors and also authors and their referees. There are many different types of such conflicts, including but not limited to student-advisor relationships, previous collaboration together, employment by the same institutions, and personal relationships (e.g., marriage, previous marriage, or parental). In specific embodiments, a system or the invention detects these conflicts and alerts the managing editor so that s/he can make a decision on how to proceed. It also provides the option to “hide” an article from the party to whom the conflict applies. While the invention obviously prevents editors who have submitted to the journal to which they are affiliated from viewing anything related to the status of their papers, but in additional the invention contains modules or subroutines to detect many different types of conflicts of interest between authors and both editors and referees. Examples of such conflict detecting subroutines are described below in relation to an academic journal in the mathematics field. The specifics are for example only, and these tools are applicable to other fields as will be understood in the art.

### Conflicts Involving Editors

### ‘coi edt Advisor Student Years’

This logic module detects a conflict between any author and the editor to whom it is assigned based on whether an advisor-advisee relationship exists between them within a certain number of years specified by the setup preferences and valid for the entire journal peer review process. A current example implementation uses the Mathematics Genealogy Project database, but the tables can be augmented to reflect any advisor-advisee relationship. In a government contracting field, for example, one or more databases relating to government contracts and contractors may be used to determine if a potential reviewer has a previous employment relationship with a submitted. As an example, the setup in the database columns are an integer of either 0, 0.1, 2, 3 etc with 0 not detecting a conflict of interest and 1 detecting a conflict within 1 year, 2 reflecting 2 years, etc.

### ‘coi edt co Author’

This logic module detects a conflict between any author of the submitted work and the editor to whom it is assigned based on whether the two have ever co authored a paper together within a specified number of years. It currently uses data from American Mathematical Society's Mathematics Reviews database and can be augmented to include any new relationships.

### ‘coi edt Same Institution’

This logic module detects a conflict between any author of the submitted work and the editor to whom it is assigned based on whether they are currently employed by the same academic institution. The determination of institutional affiliation is made by an algorithm acting on the email addresses associated with each individual.

### ‘coi edt Declared’

This logic module detects a conflict between any author and an editor as declared by any individual. An example of this would be if an author indicates to EditFlow that he is currently married to an editor. Another example would be an editor declaring an author is his daughter.

### ‘coi edt Undeclared’

This logic module detects a conflict between an author and an editor, but the reporting party does not specify the type of conflict. An example of this would be an editor stating a conflict exists, but providing no further information—i.e. that the conflict is personal.

### Conflicts Involving Referee Choices

### ‘coi ref Advisor Student’

This logic module detects a conflict between any author of the submitted work and the requested referee based on whether an advisor-advisee relationship exists between them within a certain number of years specified by the setup preferences and valid for the entire journal peer review process. The EditFlow current implementation uses the Mathematics Genealogy Project database, but the tables can be augmented to reflect any advisor-advisee relationship.

The setup in the database columns are an integer of either 0, 1, 2, 3 etc with 0 not detecting a conflict of interest and 1 detecting a conflict within 1 year, 2 reflecting 2 years, etc.

### ‘coi ref Advisor Student Years’

This logic module detects a conflict between any author of the submitted work and the requested referee based on whether an advisor-advisee relationship exists between them within a certain number of years specified by the setup preferences and valid for the entire journal peer review process. The EditFlow current implementation uses the Mathematics Genealogy Project database, but the tables can be augmented to reflect any to advisor-advisee relationship.

### ‘coi ref co Author’

This logic module detects a conflict between any author of the submitted work and the requested referee based on whether the two have ever co authored a paper together within a specified number of years. It currently uses data from American Mathematical Society's Mathematics Reviews database and can be augmented to include any new relationships.

The setup in the database columns are an integer of either 0, 1, 2, 3 etc with 0 not detecting a conflict of interest and 1 detecting a conflict within 1 year, 2 reflecting 2 years, etc.

### ‘coi ref Same Institution’

This logic module detects a conflict between any author of the submitted work and the requested referee based on whether they are currently employed by the same academic institution. The determination of institutional affiliation is made by an algorithm acting on the email addresses associated with each individual.

### ‘coi ref Current Author’

This conflict model prevents a referee from being requested that has a current pending submission in process with the journal at hand. The detection is internal and uses the EditFlow database to cross reference referee requests with the authors of current pending submissions.

### ‘coi ref People Journal’

This prevents referees from being requested who have self reported that they do not wish to be asked to referee for this journal. This can be due to personal preferences, overwork, or ideological opposition to the journal at hand.

### ‘coi ref Declared’

This logic module detects a conflict between any author and an referee as declared by any individual. An example of this would be if an author indicates to EditFlow that he is currently married to a referee. Another example would be a referee declaring an author is his daughter.

### ‘coi ref Undeclared’

This logic module detects a conflict between an author and an referee, but the reporting party does not specify the type of conflict. An example of this would be a referee stating a conflict exists, but providing no further information—i.e. that the conflict is personal.

### 9. Special Characters and Titles

According to specific embodiments of the invention, the invention includes methods and systems to handle a variety of special characters that may be encountered in various journals, particularly in academic mathematical journals. The ability to handle special characters in a variety of ways in one aspect that allows the invention to be readily customized for a variety of peer review processes.

There are several ways to input special characters in a database in use by the invention, a preferred format is Unicode, both because some browsers (such as Safari) do not accept named entities in XHTML pages, and because the Unicode representation has the benefit of being (almost) unique and as such it makes the proper identification of authors easier. However, generally input entered by authors on forms of the invention may be seen in TEX, HTML and/or Unicode. For purposes of being more generally used in different environments, names and addresses entered such as:
J¥′{e}r¥̂{o}me Z¥′{u}¥^{˜}{n}iga
   or
J&eaccute;r&ocirc;me Z&#250;&241;ga
   are corrected according to specific embodiments of the invention from their TEX and HTML forms to the Unicode:
Jérôme Zúñiga
   The Unicode representation has the benefit of being (almost) unique, while the TEX representation is very far from unique, and as such it makes the proper identification of author or other field values much harder.

### Titles

Titles of papers will sometimes require TEX code for full representation and thus, according to specific embodiments of the invention, four options are offered for to entering the title of a paper: Title, TeXTitle, HTMLTitle and MathMLTitle.

The first three are heavily used through EditFLOW for: (1) communication with authors, editors and referees by e-mail; (2) building of Metadata for the article; AND (3) visual display in EditFLOW. The last is occasionally used for building MathML metadata and for visual display in MathML capable browsers (such as Firefox).

According to specific embodiments of the invention, these four title fields are handled as follows:
TITLE is used to store the best ASCII representation of the title and may contain characters like L̂2 and L_{—}2 which are interpreted by some mailers and have a nice derived representation.
TEXTITLE is used to store a valid TEX string with all properly balanced parenthesis, braces, dollar signs, etc . . . and it may contain Unicode characters.
HTMLTITLE is used to store a valid HTML string, optionally containing Unicode when needed.
MATHMLTITLE is used to store a valid MathML string containing Unicode when needed.

As an example, consider an extreme case that requires at least three fixes of the titles using Unicode and HTML according to specific embodiments of the invention. A title entered by an author as:

The H\′{e}rron\infty-map of H_{—}2(Ŝ1,R) is \mu+1 dimensional

is converted and stored, according to specific embodiments of the invention, as the following four database entries:

TITLE: The Herron infinity-map of H_{—}2(Ŝ1,R) is mu+1 dimensional

TEXTITLE: The H\′{e}rron $\infty$-map of $H_{—}2(\mathbb{S}̂1, \mathbb{R})$ is $\mu+1$-dimensional

HTMLTITLE: The H&eaccute;rron &infin;-map of H<sub>2</sub>(<b>S</b><sup>1</sup>,<b>R<b>) is \&mu;+1 dimensional

HTMLTITLE, (other option): The Herron &#8734;-map of H<sub>2</sub>(<b>S</b><sup>1</sup>, <b>R<b>) is μ+1 dimensional

HTMLTITLE, (second other option): The Herron ∞-map of H<sub>2</sub>(<b>S</b><sup>1</sup>, <b>R<b>) is μ+1 dimensional

MATHMLTITLE: The Herron <math overflow=“scroll”><mo>∞</mo></math>-map of <math overflow=“scroll”><msub><mi>H</mi><mn>2</mn></msub><mfenced><msup><mi mathvariant=“double-struck”>S</mi><mn>1</mn></msup><mi>&#x211D;</mi></mfenced></math>is<math overflow=“scroll”><mi>p </mi><mo>+</mo><mn>1</mn></math>dimensional

Various character codes may be entered in forms and/or databases according to specific embodiments of the invention using any known or available technique. Common operating systems, such as Windows™ and MAC OS™ include various key combinations and/or drop down menus for entering special characters.

### 10. Appendix B: An Example Database Layout

Appendix B shows an example layout of a database according to specific embodiments of the invention expressed in a format familiar from SQL database applications.

### 11. General Client/Server and or Network Methods

As will be further understood from the teachings provided herein, the present invention encompasses a variety of specific embodiments for performing these steps. As described herein, communications between participants in the peer review process and the system may be effected in a variety of ways, including through one or more graphical user interfaces provided by the server system to the client system or by the server system receiving an email or other digital message or communication from the client system. Thus, according to specific embodiments of the present invention, data and/or indications can be transmitted to the server using any method for transmitting digital data, including HTML communications, FTP communications, email communications, wireless communications, etc. In various embodiments, indications of desired data can be received from a human user selecting from a graphical interface at a computing device.

### 12. Embodiment in a Programmed Information Appliance

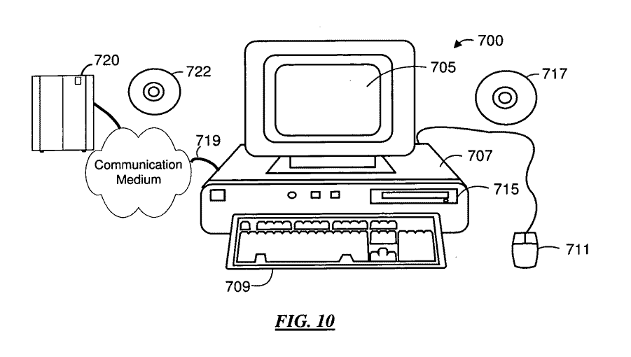

FIG. 10 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a user accesses through a communication medium in order to download a program component.

FIG. 10 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD).

In such a case, the invention may be embodied in a computer understandable descriptor language, which may be used to create an ASIC, or PLD that operates as herein described.

### 13. Other Embodiments

The invention has now been described with reference to specific embodiments. Other embodiments will be apparent to those of skill in the art. In particular, a user digital information appliance has generally been illustrated as a personal computer. However, the digital computing device is meant to be any information appliance for interacting with a remote data application, and could include such devices as a digitally enabled television, cell phone, personal digital assistant, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

Furthermore, various different actions can be used to active an active link. For example, a voice command may be spoken by the purchaser, a key may be depressed by the purchaser, a button on a client-side scientific device may be depressed by the user, or selection using any pointing device may be effected by the user.

All publications, patents, and patent applications cited herein or filed with this application, including any references filed as part of an Information Disclosure Statement, are incorporated by reference in their entirety.

What is claimed:

1. A computer implemented method for collaborative peer review of an unpublished or unapproved submission over a communications network comprising:
using a server computer system and a peer review and edit database to generate a plurality of email messages, said email messages directed to different participants in said peer review and edit process for a paper;
at least a plurality of said email messages containing an active link that is specific to a particular recipient and a particular paper;
transmitting said email messages over a communications channel with an address indication of a recipient;
receiving data over said communications channel indicating a user action and/or activation of said active link;
updating at least one data field in a said database in response to said receiving;
transmitting at least one data file or further email message over said communications channel to said recipient.

2. A computer implemented method for collaborative peer review of an unpublished or unapproved submission over a communications network comprising:
receiving a submission from an author;
storing the submission electronically in a data archive and generating an active link for the submission;
automatically generating a confirmation email to the author using a first template, the confirmation email containing at least one active link by which the author can access the submission and/or access submission status and/or provide revisions or additional information;
automatically notifying a manager that the submission has been received;
assigning an editor to a submission via a communication using a second template, the communication containing at least one active link for the submission;
contacting one or more referees via the data communications network with a referee communication using a third template, the referee communication containing at least one personalized referee active link, the referee communication requesting that the referee agree to review the submission and/or suggest additional referees;
receiving an agreement and/or suggestion from a referee using the personalized referee active link;
transmitting one or more confirmation and/or reminder emails to an agreeing referee using at least a fourth template, at least some of said emails containing the personalized referee active link;
receiving an evaluation from uploaded by a referee using the personalized referee active link;
notifying the editor that one or more evaluations have been uploaded;
notifying the author using a fifth template of a decision and/or further actions that need to be taken by the author with a communication containing at least one active link,

3. The method according to claim 1 further comprising:
storing a plurality of data fields indicating a title of said paper, said plurality of data fields comprising fields in at least two different encoding schemes.

4. The method according to claim 1 further comprising:
storing a plurality of email templates;
a plurality of said templates having one or more data merge fields for merging data from said database;
a plurality of said templates having one or more link merge fields for merging an active link generated for a particular recipient for a particular journal.

5. The method according to claim 1 further comprising:
generating one or more unique activation links for a particular recipient for a particular journal.

6. The method according to claim 1 further comprising:
storing one or more unique activation links for a particular recipient for a particular journal in said database.

7. The method according to claim 1 further comprising:
generating one or more unique activation links for a particular recipient for a particular journal for a particular action regarding said edit and peer review process.

8. The method according to claim 1 further comprising:
storing a plurality of data fields indicating a title of said paper, said plurality of data fields comprising fields in at least two different encoding schemes.

9. The method according to claim 1 further comprising:
storing a plurality of email templates;
a plurality of said templates having one or more data merge fields for merging data from said database;
a plurality of said templates having one or more link merge fields for merging an active link generated for a particular recipient for a particular journal.

10. The method according to claim 1 further comprising:
generating one or more unique activation links for a particular recipient for a particular journal.

11. The method according to claim 1 further comprising:
storing one or more unique activation links for a particular recipient for a particular journal in said database.

12. The method according to claim 1 further comprising:
generating one or more, unique activation links for a particular recipient for a particular journal for a particular action regarding said edit and peer review process.

13. A system for a peer review and edit process for publications comprising:
a server computer system;
a peer review and edit database;
a controller in said server computer system programmed to generate a plurality of messages, said messages directed to different participants in said peer review and edit process for a paper;
at least a plurality of said messages containing an active link that is specific to a particular recipient and a particular paper;
a communications interface for transmitting said messages over a communications channel with an address indication of a recipient and for receiving data over said communications channel indicating a user action and/or activation of said active link;
wherein said controller updates at least one data field in a said database in response to said receiving;
wherein said controller transmits at least one data file or further message over said communications channel to said recipient.

14. The system of claim 13 wherein said at least one data file comprises data that can be rendered as a graphical user interface at a client system with an appropriately configured browser application.

15. The system of claim 13 further comprising:
one or more conflict checking tools, each tool comprising:
a rule set for detecting a conflict using author data and one or more additional databases;
an interface to one or more additional databases;
an output for outputting conflict indication data.

16. The system of claim 13 further comprising:
a questionnaire regarding specifics of a particular review process;
wherein a review flow of a system can be modified as a result of responses to said questionnaire.

17. A computer readable medium containing computer interpretable instructions describing a circuit layout for an integrated circuit that, when constructed according to said descriptions, will configure a circuit to embody the system described in claim 13.

18. A computer readable medium containing computer interpretable instructions that when loaded into an appropriately configured information processing device will cause the device to operate in accordance with claim 1.
